(19) United States
(12) Patent Application Publication
(10) Pub. No.: US 2021/0300603 A1
(43) Pub. Date: Sep. 30, 2021

(54) EVAPORATORS, LIQUID COOLING VENTILATION GARMENTS WITH EVAPORATORS, AND ENVIRONMENTAL CONTROL METHODS

(71) Applicant: Hamilton Sundstrand Corporation, Charlotte, NC (US)

(72) Inventor: Gregory John Quinn, Windsor, CT (US)

(21) Appl. No.: 16/829,238

(22) Filed: Mar. 25, 2020

(51) Int. Cl. B64G 6/00; A41D 13/005; F24F 5/00

(52) U.S. Cl. CPC B64G 6/00; F24F 5/0035; A41D 13/0056

(57) ABSTRACT

An evaporator includes a housing with an inlet and an outlet, a hydrophobic hollow fiber membrane contained within the housing and fluidly coupling the inlet to the outlet, and a conduit. The conduit extends fluidly along the housing and fluidly couples the inlet to the hydrophobic hollow fiber membrane to heat the housing with water mixture introduced through the inlet of the housing prior to communication of the water to the hydrophobic hollow fiber membrane. Liquid cooling ventilation garments and environmental control methods are also described.

### BACKGROUND

The present disclosure is generally directed to environmental control for garments, and more particularly to environmental control using evaporators employing hydrophobic hollow fiber membranes.

Evaporative cooling systems, such as in space vehicles and spacesuits, are commonly employed to provide environmental control. The evaporative cooling system generally includes a coolant pump, a coolant circuit, and an evaporator. The coolant pump circulates liquid water though the coolant circuit such that chilled water entering the space vehicle or spacesuit is heated and communicated to the evaporator. The evaporator evaporates a portion of the heated water as water vapor, chilling the remaining water for recirculation through the coolant circuit and rejecting the water vapor (and heat) to the ambient environment. Such evaporators typically employ a hollow fiber membrane, which channels the heated water through a low pressure (or evacuated) space to separate water vapor and cool the water as it flows through the channels within the hollow fiber membrane.

One challenge to evaporators employing fiber membranes (e.g., hollow fiber members) is keeping the exterior of the fibers forming the membrane dry. Specifically, if water comes into contact with the exterior of a fiber the fiber leaks, water flowing through the fiber and flooding the chamber housing the hollow fiber membrane and shutting down the evaporative cooling process. Water can accumulate within the chamber, for example, when the walls of the chamber cool to a temperature below that of the water vapor issuing from the hollow fiber membrane.

Such systems and methods have generally been acceptable for their intended purpose. However, there remains a need for improved evaporators, liquid cooling ventilation garments employing evaporators, and environmental control methods employing such evaporators.

### BRIEF DESCRIPTION

Disclosed is an evaporator. The evaporator can be used, for example, in or in combination with space vehicles and spacesuits. The evaporator includes a housing with an inlet and an outlet and a hydrophobic membrane contained within the housing and fluidly coupling the inlet to the outlet. The evaporator also includes a conduit fluidly extending along the housing and fluidly coupling the inlet to the hydrophobic membrane to heat the housing with water introduced through the inlet of the housing prior to communication of the water to the hydrophobic membrane.

In addition to one or more of the features described above, or as an alternative to any of the foregoing embodiments, the housing has an interior surface, and wherein the conduit is thermally coupled to the interior surface of the housing.

In addition to one or more of the features described above, or as an alternative to any of the foregoing embodiments, the conduit is connected to the housing by a bond, a weld, a clamp, or a fastener.

In addition to one or more of the features described above, or as an alternative to any of the foregoing embodiments, the conduit and the housing are integrally formed as a conduit portion and a housing portion in a solid, one-piece housing/conduit body.

In addition to one or more of the features described above, or as an alternative to any of the foregoing embodiments, the hydrophobic membrane is a hydrophobic hollow fiber membrane and the evaporator further includes an inlet header fluidly coupling the conduit to the hydrophobic hollow fiber membrane.

In any embodiment herein, the hydrophobic membrane can be a hydrophobic hollow fiber membrane.

In addition to one or more of the features described above, or as an alternative to any of the foregoing embodiments, the inlet header is seated on the housing and fixed thereto by a bond, a weld, a clamp, or a fastener.

In addition to one or more of the features described above, or as an alternative to any of the foregoing embodiments, the inlet header and the housing are integrally formed as an inlet header portion and a housing portion in a solid, one-piece housing/conduit body.

In addition to one or more of the features described above, or as an alternative to any of the foregoing embodiments, the evaporator may further include an outlet header fluidly coupling the hydrophobic hollow fiber membrane to the outlet.

In addition to one or more of the features described above, or as an alternative to any of the foregoing embodiments, the outlet header is seated on the housing and is fixed thereto by a bond, a weld, a clamp, or a fastener.

In addition to one or more of the features described above, or as an alternative to any of the foregoing embodiments, the outlet header and the housing are integrally formed as an outlet header portion and a housing portion in a solid, one-piece housing/conduit body.

In addition to one or more of the features described above, or as an alternative to any of the foregoing embodiments, the evaporator further includes an orifice or a steam valve seated in the housing, wherein the hydrophobic hollow fiber membrane is in fluid communication with an external environment outside the housing by the orifice or steam, valve.

In addition to one or more of the features described above, or as an alternative to any of the foregoing embodiments, the evaporator further includes a feedwater source fluidly coupled to the outlet of the housing by the inlet of the housing.

Technical effects of the present disclosure include evaporators with relatively high reliability and reduced probability of shutdown due to condensate accumulation within the evaporator. In certain examples evaporators described herein can operate with housing interior surfaces warmer than the temperature of water vapor issuing through walls of the hollow hydrophobic hollow fiber membrane employed for separation within the evaporator, limiting (or preventing entirely) water vapor condensation within the evaporator. In accordance with certain examples evaporators employ solid, one-piece housing bodies with relatively low thermal resistance between the conduit conveying the mixed state water provided to the evaporator and the interior surface of the evaporator. The relatively low thermal resistance limits the temperature differential between the water vapor existing the hydrophobic hollow fiber membrane and the mixed state water communicated to the evaporator required for reliable operation of the evaporator.

### BRIEF DESCRIPTION OF THE DRAWINGS

The following descriptions should not be considered limiting in any way. With reference to the accompanying drawings, like elements are numbered alike:

FIG. 1 is a schematic view of a liquid cooling ventilation garment constructed in accordance with the present disclosure, showing a coolant circuit including an evaporator and a feedwater source fluidly coupled to the liquid cooling ventilation garment;

FIG. 2 is a schematic view of the evaporator of FIG. 1 according to an example, showing a housing with a conduit fixed to the housing and fluidly coupling an inlet of the housing to a hydrophobic hollow fiber membrane contained within the housing;

FIG. 3 is an axial cross-sectional view of the evaporator of FIG. 1 according to an example, showing each of a bond, a weld, a clamp, and a fastener connecting the conduit to the housing;

FIG. 4 is a schematic view of the evaporator of FIG. 1 according to an example, showing a housing with a solid, one-piece body with a conduit fluidly coupling an inlet of the housing to a hydrophobic hollow fiber membrane contained within the housing; and

FIG. 5 is a block diagram of an environmental control method, showing operations of the method according to an illustrative and non-limiting example of the method.

### DETAILED DESCRIPTION

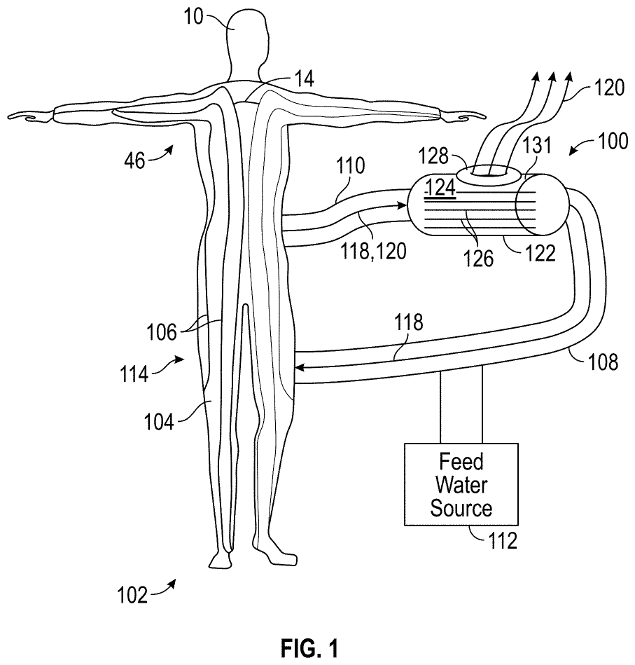

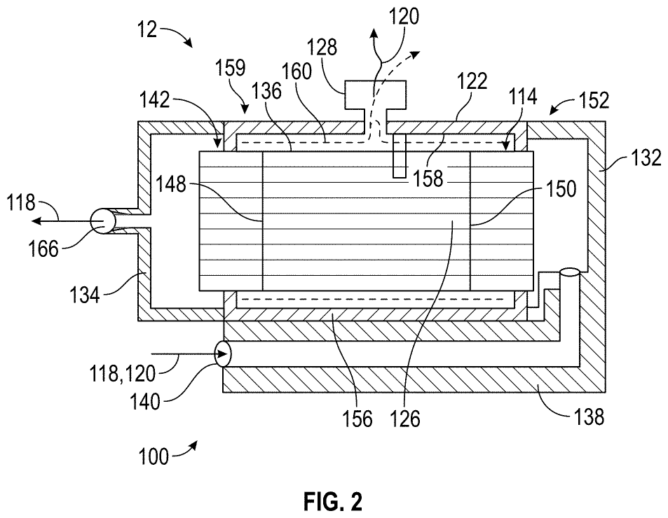

Reference will now be made to the drawings wherein like reference numerals identify similar structural features or aspects of the subject disclosure. For purposes of explanation and illustration, and not limitation, a partial view of an example of a liquid cooling ventilation garment with an evaporator constructed in accordance with the disclosure is shown in FIG. 1 and is designated generally by reference character 102. Other embodiments of liquid cooling ventilation garments, evaporators, and environmental control methods in accordance with the present disclosure are provided in FIGS. 2-5, as will be described. The systems and methods described herein can be used to provide environmental control vehicles and wearables, such as in spacesuit and in space vehicles, through the present disclosure is not limited to space applications or to vehicles and garments generally.

With reference to FIG. 1, a liquid cooling ventilation garment 102 is shown. The liquid cooling ventilation garment 102 includes a garment 104 with cooling channels 106 defined therein, a supply conduit 108, and a return conduit 110. The liquid cooling ventilation garment 102 also includes a feedwater source 112 and the evaporator 100. The garment 104 includes a garment portion 114 arranged for wear by a user 10 and a channel portion 116 defining the cooling channels 106. The supply conduit 108 is connected to the garment 104, is in fluid communication with the cooling channels 106, and fluidly couples the evaporator 100 to the cooling channels 106. The return conduit 110 is connected to the garment 104, is in fluid communication with the cooling channels 106 and is fluidly coupled thereby to the supply conduit 108, and fluidly couples the cooling channels 106 to the evaporator 100. The feedwater source 112 is fluidly coupled to the cooling channels 106, e.g., via connection to the supply conduit 108, for circulation of liquid water 118 through the cooling channels 106 and the evaporator 100 via the supply conduit 108 and the return conduit 110.

During operation the liquid water 118 is circulated through the cooling channels 106. As the liquid water 118 is circulated through the cooling channels 106 the liquid water 118 absorbs heat H from the user 10. The heat H evaporates a portion of the liquid water 118, forming a water vapor 120 in the evaporator. The water vapor 120, once formed, is entrained within the liquid water 118 and as carried through the cooling channels 106. At the completion of a cycle through the liquid cooling ventilation garment 102 the cooling channels 106 communicate the liquid water 118 to the evaporator 100.

The evaporator 100 is configured for separating the water vapor 120 from the liquid water 118. In this respect the evaporator 100 includes a housing 122 with an interior 124, a hydrophobic membrane 126 arranged within the interior 124 of the housing 122, an inlet header 130 (shown in FIG. 2) fluidly coupling the supply conduit 108 to the hydrophobic membrane 126, and an outlet header 134 (shown in FIG. 2) fluidly coupling the hydrophobic membrane 126 to the return conduit 110. In one embodiment and as illustrated, the hydrophobic membrane 126 is a hydrophobic hollow fiber membrane. The membrane 126 is not so limited however and include mechanical forms of a microporous membrane such, as, for example, sheet membranes.

During operation the interior 124 is typically maintained at relatively low pressure, e.g., under vacuum, such that water vapor 120 separated from the liquid water 118 is promptly ejected from the interior 124 of the housing 122 through an orifice or steam valve 128 fluidly coupling the interior 124 of the housing 122 to the external environment 12. The liquid water 118 issuing from the hydrophobic hollow fiber membrane 126 is collected by the outlet header 134 and provided to the return conduit 110, which in turn communicates the liquid water 118 and feedwater 178 received from the feedwater source 112 to the liquid cooling ventilation garment 102.

As will be appreciated by those of skilled in the art, the hydrophobic membrane 126 is able to separate the water vapor 120 from the water 118 while an exterior 136 of the hydrophobic membrane 126 remains dry. As will also be appreciated by those of skill in the art in view of the present disclosure, keeping the hydrophobic membrane 126 requires that the water vapor 120 traversing the interior 124 of the housing 122 not be permitted to condense (in any meaningful amount), such as by coming into contact with structures that relatively cool with respect the water vapor 120. To reduce (or eliminate entirely) the likelihood of condensation the evaporator 100 includes a conduit 138 (shown in FIG. 2). The conduit 138 is in thermal communication with the housing 122 and fluidly couples an inlet 140 (shown in FIG. 2) of the evaporator 100 to the inlet header 130, the conduit 138 thereby heating the housing 122 with the water 118 prior to introduction to the hydrophobic membrane 126. As will be appreciated by those of skill in the art in view of the present disclosure, heating the housing 122 limits (or eliminates entirely) likelihood of the water vapor 120 condensing upon contact with an interior surface of the housing 122.

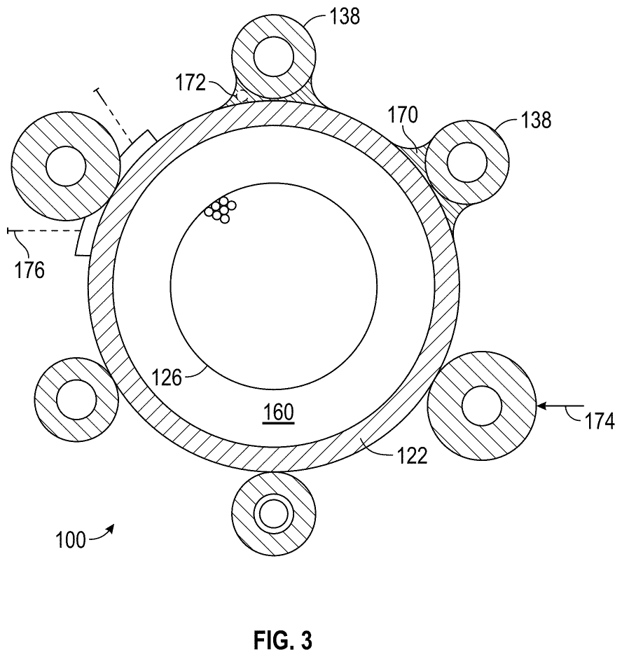

With reference to FIGS. 2 and 3, the evaporator 100 is shown according to an example. As shown in FIG. 2, the evaporator 100 includes the housing 122, the hydrophobic membrane 126, the orifice or steam valve 128, and the inlet header 132. The evaporator 100 also includes the outlet header 134, the conduit 138, and has the inlet 140 and an outlet 166.

The illustrated hydrophobic membrane 126 has a first end 142, a second end 144, and a plurality of hollow fibers 146 extending between the first end 142 and the second end 144 of the hydrophobic membrane 126. The first end 142 of the hydrophobic membrane 126 is encased within a first end monolithic block 148 (e.g., a resin block) binding the hydrophobic membrane 126 in a roll and arranged such that the first end 142 of the hydrophobic membrane 126 (and thereby the fiber ends) are in fluid communication with the inlet header 132. The second end 144 of hydrophobic membrane 126 is similarly encased within a second end monolithic block 150 (e.g., also a resin block) binding the hydrophobic membrane 126 in the roll, and is additionally arranged such that the second end 144 of the hydrophobic membrane 126 is in fluid communication with the outlet header 134. As discussed above, in one embodiment, the hydrophobic membrane 126 are hydrophobic hollow fiber membranes. Examples of suitable hydrophobic hollow fiber membranes include Membrana® microporous membranes, available from the 3M Corporation of St. Paul, Minn. Examples of suitable hydrophobic membranes are described in U.S. Pat. No. 5,562,949 which is incorporated herein by reference.

The housing 122 has an inlet end 152, an outlet end 154, and is formed from a thermally conductive material 156, such as aluminum or an alloy thereof. The hydrophobic membrane 126 is contained within the interior 124 of the housing 122 such that the first end 142 of the hydrophobic membrane 126, and more specifically the first end monolithic block 148, communicates with the inlet end 152 of the housing 122, and that the second end 144 of the hydrophobic membrane 126 communicates with the outlet end 154 of the housing 122. An interior surface 158 of the housing 122 and the exterior 136 of the hydrophobic membrane 126 define therebetween a plenum 160, and the orifice or steam valve 128 is seated in the housing 122 between the inlet end 152 and the outlet end 154 to fluidly couple the plenum 160 to the external environment 12 outside of the evaporator 100.

The inlet header 132, the outlet header 134, and the conduit 138 are each fixed to the housing 122. In this respect the inlet header 132 is fixed to the inlet end 152 of the housing 122 and defines an inlet header port 164 therein, and the outlet header 134 is fixed to the outlet end 154 of the housing 122 and the outlet 166 of evaporator 100. The conduit 138 extends fluidly along the housing 122 and fluidly couples the inlet 140 to the outlet 166 to heat the housing 122 with heat, e.g., the heat H (shown in FIG. 1), with the water 118 introduced through the inlet 140 prior to communication of the water v118 to the hydrophobic membrane 126.

It is contemplated that supply conduit 108 be connected to the inlet 140 of the conduit 138, that the return conduit 110 be connected to the outlet 166, and that the conduit 138 be fixed to the housing 122. In the illustrated example the conduit 138 is connected to the housing 122, defines the inlet 140 of the evaporator 100, and is connected to the inlet header port 168 on an end opposite the inlet 140. Between the inlet 140 and the inlet header port 168 the conduit 138 is in thermal communication with the housing 122 at least partially (and in certain embodiments substantially entirely) along its length between the inlet 140 and the inlet header port 168 to heat the housing 122 with at least a portion of the heat H (shown in FIG. 1).

As shown in FIG. 3, fixation of the conduit 138 to the housing 122 can be by way of a weld 170. Alternatively (or additionally), as also shown in FIG. 3, fixation of the conduit 138 to the housing 122 can be by way of a bond 172. Further, in accordance with certain examples, fixation of the conduit 138 to the housing 122 can be by way of a clamp 174 and/or a fastener 176. Although a certain number of conduits 138 are shown in the illustrated example, e.g., six (6) conduits 138, those of skill in the art will appreciate that examples of the evaporator 100 can have fewer than six (6) conduits or more than six (6) conduits, as suitable for an intended application.

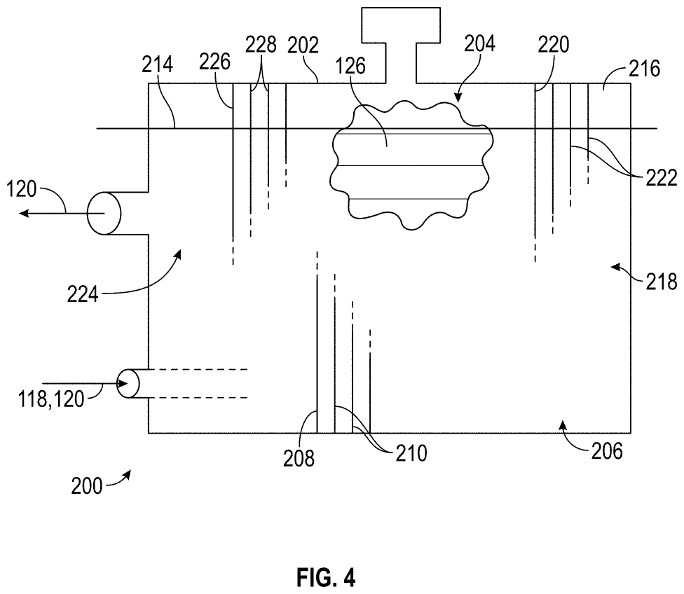

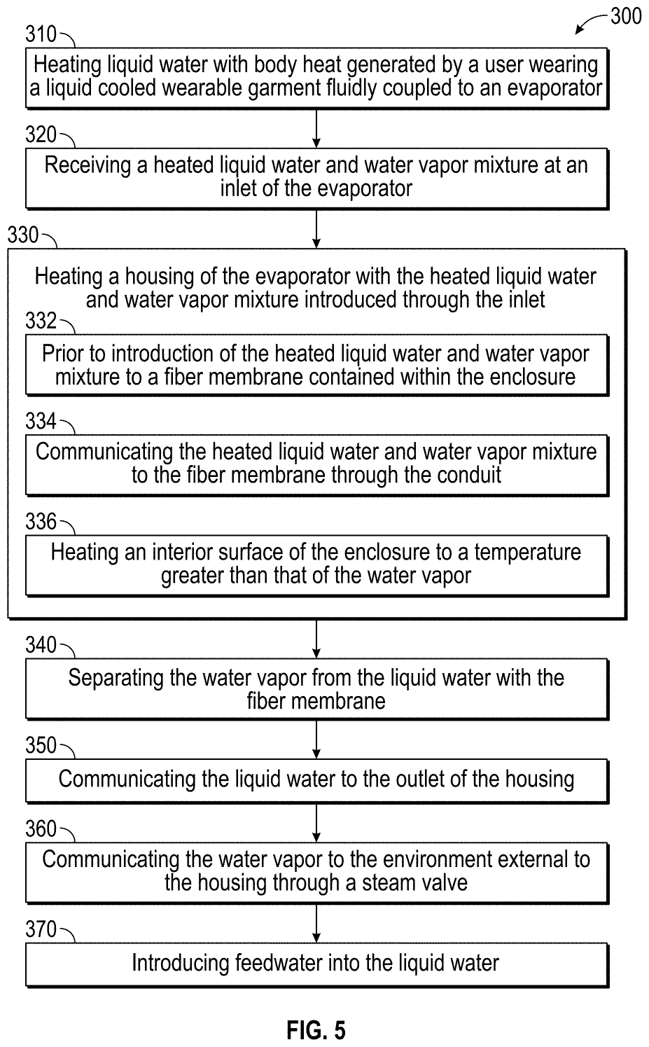

With reference to FIGS. 4 and 5, an evaporator 200 is shown. The evaporator 200 is similar to the evaporator 100 (shown in FIG. 1) and additionally includes a solid, one-piece housing/conduit body 202. As used herein the term solid, one-piece body refers to monolithic body of homogenous composition and integrating there at least two features that otherwise require integration by assembly of separate structures.

As shown in FIG. 4, the solid, one-piece housing/conduit body 202 has a housing portion 204 and a conduit portion 206. The housing portion 204 and the conduit portion 206 are formed from a plurality layers using an additive manufacturing technique and include a first layer 208 and two or more second layers 210 fused to the first layer 208, for example, using a laser sintering or a power bed fusion technique. As will be appreciated by those of skill in the art in view of the present disclosure, forming the evaporator 200 with the solid, one-piece housing/conduit body 202 allows the conduit portion 206 to communicate thermally with the housing portion 204 directly, i.e., without an intermediate (and thermally resistant) joint, allowing for relatively high efficiency of thermal communication of heat, e.g., the heat H (shown in FIG. 1), between the water 118 traversing the conduit 138 and an interior surface 212 of the housing portion 204.

As also shown in FIG. 4, it is contemplated that either (or both) an inlet header 214 and an outlet header 216 be incorporated in the solid, one-piece housing/conduit body 202. In this respect the solid, one-piece housing/conduit body 202 can include an inlet header portion 218 defined by a fused particulate inlet header first layer 220 and two or more fused particulate inlet header second layers 222, the two or more fused particulate inlet header second layers 222 fused to the fused particulate inlet header first layer 220. In further respect, as also shown in FIG. 4, the solid, one-piece housing/conduit body 202 includes an outlet header portion 224 defined by a fused particulate outlet header first layer 226 and two or more fused particulate outlet header second layers 228, the two or more fused particulate outlet header second layers 228 fused to the fused particulate outlet header first layer 226. Although shown and described herein as having both the inlet header portion 218 and the outlet header portion 220, those of skill in the art will appreciate that examples of the evaporator 200 can have only one of the inlet header portion 218 and the outlet header portion 224 and remain within the scope of the present disclosure.

With reference to FIG. 5, an environmental control method 300 is shown. As shown with box 310, the method 300 includes heating liquid water with body heat generated by a user wearing a liquid cooled wearable garment fluidly coupled to an evaporator, the user 10 (shown in FIG. 1) generating the heat H (shown in FIG. 1) wearing the liquid cooling ventilation garment 102 (shown in FIG. 1) coupled to the evaporator 100 (shown in FIG. 1). As shown with box 320, a resulting heated water vapor/liquid water mixture is received at an inlet of the evaporator, e.g., the heated water 118 (shown in FIG. 1) at the inlet 140 (shown in FIG. 2). As shown with box 330, a housing, e.g., the housing 122 (shown in FIG. 1) of the evaporator is heated with the water vapor/liquid water mixture introduced to the inlet, heating the housing to limit (or eliminate entirely) probability that condensation will form on an interior surface of the housing.

In certain examples the heating of the housing is accomplished prior to introduction of the heated liquid water and water vapor mixture into fibers of a hydrophobic membrane contained within the housing, e.g., the hydrophobic hollow fiber membrane 126 (shown in FIG. 1), as shown with box 332. In accordance with certain examples, the heated water vapor and liquid water mixture can be communicated to the hydrophobic hollow fiber membrane through a conduit extending along the housing, e.g., the conduit 138, as shown with box 334. It is contemplated that, in accordance with certain examples, that an interior surface of the housing be heated to a temperature greater than water vapor traversing micropores fined within walls of fibers of the hydrophobic hollow fiber membrane, e.g., that the interior surface 158 (shown in FIG. 2) of the housing be warmer than water vapor traversing micropores of the hollow fibers 146 (shown in FIG. 2), as shown with box 336.

As shown with box 340, the method 300 can also include separating the water vapor from the liquid water using the fibers of the hydrophobic membrane. As shown with box 350, the method 300 can additionally include communicating the liquid water to an outlet of the housing, e.g., the outlet 162 (shown in FIG. 2). It is also contemplated that the method 300 can include communicating the water vapor to the external environment through an orifice or a steam valve, e.g., the orifice or steam valve 128 (shown in FIG. 2), as shown with box 360. In further examples the method 300 can include introducing feedwater into the liquid water, e.g., the feedwater 178 (shown in FIG. 1), as shown with box 370.

Evaporative cooling can be employed in wearables, such as exploration space suit, to provide environmental control to the occupant of the suit by flowing water through hydrophobic membranes. The outside of the hydrophobic membranes can be exposed to very low pressure inside a housing to cause entrained water vapor to evaporate through the membranes. Once evaporated through the hydrophobic membrane the water vapor can be ejected to the environment external to the housing, e.g., through an orifice and/or a steam valve. Such evaporators can provide reliable environmental control absent wetting of the exterior of the hydrophobic membrane, such as in the event that water vapor condenses on the interior of the housing and accumulates within the housing should the interior of the housing become cooler than the water vapor.

In examples described herein the evaporators receives warm water with entrained water vapor at an inlet header via a conduit with inlet at one end and discharges chilled water via an outlet header at an opposite end of the evaporator. The conduit routs the warm water and entrained water vapor over the housing starting from the outlet header end, gathers the (now cooled) warm water and entrained water vapor in the inlet header, and flows the warm water and entrained water vapor through the hydrophobic membrane. In certain examples the water and entrained water vapor flows over the housing in built-in water channels. In accordance with certain examples the water and entrained water vapor is connected to the housing walls via bonds, welds, clamps, and/or fasteners.

Advantageously, routing the warm water and entrained water vapor over the housing prior to introducing the water vapor/liquid water mixture into the hydrophobic membrane ensures that the housing remains warmer than the steam traversing the walls via micropores defined within the hydrophobic membrane and entering the plenum defined within the interior of the housing. This prevents the steam/vapor from condensing within the interior of the housing, which could otherwise wet (contact) fibers of the hydrophobic hollow fiber membrane, cause the wetted fibers to no longer be hydrophobic and leak water, reducing reliability of the evaporator.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An evaporator, comprising:
a housing with an inlet and an outlet;
a hydrophobic membrane contained within the housing and fluidly coupling the inlet to the outlet; and
a conduit fluidly extending along the housing and fluidly coupling the inlet to the hydrophobic membrane to heat the housing with water introduced through the inlet of the housing prior to communication of the water to the hydrophobic hollow fiber membrane.

2. The evaporator of claim 1, wherein the housing has an interior surface, and wherein the conduit is thermally coupled to the interior surface of the housing.

3. The evaporator of claim 2, wherein the conduit is connected to the housing by a bond, a weld, a clamp, or a fastener.

4. The evaporator of claim 1, wherein the conduit and the housing are integrally formed as a conduit portion and a housing portion in a solid, one-piece housing/conduit body.

5. The evaporator of claim 1, wherein the hydrophobic membrane is a hydrophobic hollow fiber membrane and the evaporator further includes an inlet header fluidly coupling the conduit to the hydrophobic hollow fiber membrane.

6. The evaporator of claim 5, wherein the inlet header is seated on the housing and fixed thereto by a bond, a weld, a clamp, or a fastener.

7. The evaporator of claim 5, wherein the inlet header and the housing are integrally formed as an inlet header portion and a housing portion in a solid, one-piece housing/conduit body.

8. The evaporator of claim 5, further comprising an outlet header fluidly coupling the hydrophobic hollow fiber membrane to the outlet.

9. The evaporator of claim 8, wherein the outlet header is seated on the housing and is fixed thereto by a bond, a weld, a clamp, or a fastener.

10. The evaporator of claim 8, wherein the outlet header and the housing are integrally formed as an outlet header portion and a housing portion in a solid, one-piece housing/conduit body.

11. The evaporator of claim 1, further comprising an orifice or a steam valve seated in the housing, wherein the hydrophobic membrane is in fluid communication with an external environment outside the housing by the orifice or steam, valve.

12. The evaporator of claim 1, further comprising a feedwater source fluidly coupled to the outlet of the housing by the inlet of the housing.
